(19) United States
(12) Patent Application Publication
(10) Pub. No.: US 2003/0166489 A1
(43) Pub. Date: Sep. 4, 2003

(54) Process for production of detergent tablets

(75) Inventors: Adrianus Comelis Van Asten, Vlaardingen (NL); Daniel Albert Van Doorn, Vlaardingen (NL); Antje Minke Wierenga, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/323,403

(22) Filed: Dec. 19, 2002

(30) Foreign Application Priority Data
Dec. 20, 2001 (GB) 0130498.9

(51) Int. Cl. C11D 17/00

(52) U.S. Cl. 510/440; 510/445; 510/446; 510/447

(57) ABSTRACT

A method of making a compacted granular detergent tablet comprising a clay component, said method comprising the steps of:

(i) adsorbing and/or absorbing a perfume onto the clay component to form a perfumed clay component;

(ii) admixing the perfumed clay component with at least one other functional detergent component; and

(iii) compacting the composition formed in step (ii) into a detergent tablet.

### FIELD OF THE INVENTION

The present invention relates to detergent tablet compositions comprising clay perfume carriers and methods for making them. Such tablets provide improved perfume stability and allow high perfume loadings, while maintaining or improving dissolution of the tablets, even upon prolonged storage.

### BACKGROUND OF THE INVENTION

The use of perfumes in granular detergent compositions to impart a pleasant odour to the neat product and washed clothing is well known. In many such compositions, perfume is simply sprayed on the other components of the composition. Alternatively, it is known to employ perfume carriers such as clay mineral components or zeolites, as described in GB-A-2 140 820 and GB-A-2 141 730.

Perfumes may also be used in detergent tablets. For example, perfume carriers are disclosed in WO-A-99/45091, which describes fragrant beads of perfume comprising actives-PEG-perfume mixtures.

WO-A-99/21955 describes incorporating perfume into detergent tablets by including it in a solid premix, granulating the premix and compacting the composition to form tablets. The perfume in the tablets is therefore homogeneously incorporated throughout the tablets.

However, the use of perfumes in detergent tablet compositions is not without problems. For example, use of perfume in detergent tablets has been found to reduce the rate of dissolution and disintegration of tablets, particularly at high perfume levels, and also cause discoloration of the clay.

Other problems associated with perfumes are referred to in WO-A-00/55287 and WO-A-00/55294. These documents describe the detrimental effect which results when such tablets comprise a clay mineral compound in combination with a perfume. The interaction between these two components leads to discoloration of the clay, and may also result in the tablet having a less attractive odour. The applications claim perfumed detergent tablets comprising clay mineral compounds in combination with either (i) a perfume containing less than 0.6% of Schiff-base; or (ii) a perfume and a heavy metal ion sequestrant, with the perfume in each case preferably being sprayed onto the tablet.

In addition to problems caused by the interaction of perfumes and clays, perfumes are capable of interacting with both the atmosphere and other reactive components of the tablet such as bleaches or enzymes. As disclosed in WO-A-99/27069, these interactions may cause undesirable effects, such as degradation of the perfume and an associated loss of smell or production of undesirable odours. This document discloses detergent tablets comprising a compressed portion and a non-compressed portion, with the perfume component being suspended in or dispersed within the non-compressed portion. Similarly, WO-A-00/11132 describes dual-layer tablets where the perfume is contained in the opposite layer to the bleach component to prevent degradation of the perfume.

WO-A-00/75273 and WO-A-00/11132 describe multiphase tablets having different levels of perfume in the layers, and having perfume components and bleaches separated into different levels. The applications describe improved tablet disintegration and perfume stability. However, there is no disclosure that such benefits are maintained upon storage of the tablets.

We have now found that, in contrast to previous experience and the teaching of the prior art, clays can be used as effective perfume carriers without negatively impacting on tablet dissolution. The affinity of perfume for clay allows high perfume loadings, hence only a small amount of clay is required to provide the desired level of perfume in the tablet. Furthermore, the affinity of perfume for clay provides improved perfume stability over time, and leads to less “leakage” of perfume during storage of the product.

### DEFINITION OF THE INVENTION

The present invention provides a method of making a compacted granular detergent tablet comprising a clay component, the method comprising the steps of:

(i) adsorbing and/or absorbing a perfume onto the clay component to form a perfumed clay component;

(ii) admixing the perfumed clay component with at least one other functional detergent component; and

(iii) compacting the composition formed in step (ii) into a detergent tablet.

The present invention also provides a method of making a multi-zone detergent tablet comprising the steps of:

(i) forming a first tablet zone according to the described above; and

(ii) forming a second tablet zone comprising at least one functional detergent component in contact with said first tablet zone to form a multi-zone detergent tablet.

### DETAILED DESCRIPTION OF THE INVENTION

Perfumed Clay Component

The perfumed clay component is formed in step (i) of the first method described above. The perfumed clay component may be made by spraying perfume onto the clay with mixing, for example, in a rotating drum. The perfume is allowed to adsorb/absorb onto the clay over time to obtain even application of perfume.

If the tablet is composed of a single, generally homogeneous composition, then the perfumed clay generally comprises from 0.5 to 95 wt %, preferably 5 to 20 wt % of the total detergent tablet. Alternatively, if the tablet is a multi-zone tablet comprising a plurality of distinct tablet zones, then the composition of at least one of the tablet zones will preferably comprise from 0.5 to 95 wt %, preferably 5 to 20 wt % of perfumed clay.

In the case of a multi-zone tablet, the zone(s) containing the perfumed clay preferably comprise from 5 to 95 wt % of the multi-zone detergent tablet, more preferably from 10 to 50 wt %.

In a preferred embodiment, the tablet is a two-layer tablet, with one layer containing the perfumed clay, and the other layer being essentially free of perfumed clay.

The individual clay and perfume components will now be described in more detail.

Clay Component

It is preferred that the clay component used to prepare the perfumed clay component is a fabric softening smectite clay. Smectites are 2:1 clay minerals in which aluminium oxide or magnesium are present in a silicate lattice.

Suitable smectite clay minerals include montmorillonite, beidellite, hectorite, nontronite, saponite and sauconite, particularly those having an alkali or alkaline earth metal ion between the clay mineral layers. Montmorillonite is the preferred mineral, and clays which contain a majority of montmorillonite, such as bentonite, are a preferred source of this clay mineral. It may be preferred that the clay is at least 90% montmorillonite. Bentonites containing calcium or sodium montmorillonite (known as calcium or sodium bentonites) are particularly preferred.

Suitable bentonite clays are sold under the trade names of Laundrosil DW, M630 Agglomerat and EX 0276 Agglomerat clays available from Sud Chemie, Germany; Detersoft G1S, Detersoft G1B, Detercal G1 FC and Detercal G2 FC clays, available from Laviosa, Italy; and Bentonite QPC 200G and QTIC 200G clays available from Colin Stewart Minerals, UK.

It is preferred that the majority of the clay particles are granulated to a particle size between 10 microns and 1000 microns. It is further preferred that 90% of the clay particles have diameters between 300 microns and 1000 microns, more preferably between 500 microns and 800 microns. A particularly preferred clay has particles of between 600 microns and 700 microns, with 1-2% of fines.

The clay component is preferably present at a level from 0.5 to 40% by weight of the tablet, these percentages referring to the level of the clay component per se. The upper limit on the level of clay mineral may be as low as 8 wt %, 10 wt %, 15 wt %, 20 wt % or 30 wt %, with 10 wt % being particularly preferred. The lower limit on the level of clay mineral may be 1 or 3 wt %, or even 5 wt %.

Clays are available in which the amount of crystalline silica is below 5 wt %, and these are suitable for use in the present invention. It may be preferred that in the present invention the chromium, nickel and cobalt levels in the tablet, which usually arise due to these trace elements being found in clays, are less than 5 ppm.

The clay component may comprise minor amounts of other components or impurities. However, it is preferred that, prior to application of the perfume, it is at least 95 wt %, more preferably 99 wt % clay.

Perfume

The perfume composition used to prepare the perfumed clay component will normally consist of a plurality of perfumery materials having a fragrance, and may include a minor proportion (less than 50% by weight of the perfume, e.g. 20 wt %) of odourless organic solvent which serves as a carrier.

Perfume compositions suitable for use in fabric washing have been disclosed in various documents including EP-A-332259 (Procter) and are available from perfume houses such as Quest International, IFF, Givaudan, Takasago, Haarmann & Reimer and Dragaco. A perfume composition may have deodorant properties, as disclosed in U.S. Pat. No. 4,304,679, U.S. Pat. No. 4,663,068, U.S. Pat. No. 5,501,805 and U.S. Pat. No. 5,554,588.

The amount of perfume adsorbed and/or absorbed onto the clay is preferably such as to provide a perfumed clay component comprising from 0.1 to 30 wt % perfume, more preferably from 2 to 10 wt %.

The total amount of perfume in a tablet is likely to be from 0.1 to 5% by weight of the tablet, preferably from 0.1 to 1%. In many fabric washing products, the amount of perfume is less than 1%. The total amount of perfume in a tablet may therefore be in a range from 0.1 to 0.5%.

Oil Soluble Dye

In a preferred embodement of the invention the clay composition may also comprise a dye, preferably an oil soluble dye. This dye is preferably absorbed and/or adsorbed onto the day composition.

Suitable levels of dye (based on the weight of the clay) are from 0.001 to 0.0.1 wt %.

Preferred dyes are be selected from dyes which are generally considered suitable for use in food and or detergent applications.

Preferably the dye is mixed with the perfume component and the mixture of perfume and dye is then subsequently applied to the clay component.

Other Components:

Step (ii) of the process of the present invention requires admixture of the perfumed clay component with at least one other functional detergent component. As used herein, “functional detergent component” means a material which provides a beneficial effect in the cleaning of laundry articles using detergent compositions. A non-exhaustive list of such functional detergent components comprises detergent actives, surfactants, detergency builders, bleaches, enzymes, fabric softeners, fluorescers, polymers (e.g. soil release or anti-redeposition agents), foam suppressers and corrosion inhibitors.

Detergent-Actives

Compositions which are compacted in tablets of this invention contain one or more detergent-actives. In a fabric washing composition, these preferably provide from 5% to 50% by weight of the overall tablet composition, more preferably from 8 or 9% by weight of the overall composition up to 25, 40 or 50% by weight. The detergent-active may be anionic (soap or non-soap), cationic, zwitterionic, amphoteric, nonionic or any combination of these. Many suitable detergent surfactants are commercially available and are fully described in the literature, for example in “Surface Active Agents and Detergents”, Volumes I and II, by Schwartz, Perry and Berch.

Anionic surfactant is present in an amount of from 0.5 to 40% by weight, preferably from 2% or 4% up to 20%, 30% or 40% by weight of the tablet composition.

Synthetic (i.e. non-soap) anionic surfactants are well known to those skilled in the art. Examples include alkylbenzene sulphonates, particularly sodium linear alkylbenzene sulphonates having an alkyl chain length of C₈-C₁₅; olefin sulphonates; alkane sulphonates; dialkyl sulphosuccinates; and fatty acid ester sulphonates.

Primary alkyl sulphate having the formula ROSO₃⁻M⁺ in which R is an alkyl or alkenyl chain of 8 to 18 carbon atoms especially 10 to 14 carbon atoms and M+is a solubilising cation, is commercially significant as an anionic surfactant.

Linear alkyl benzene sulphonate of the formula:

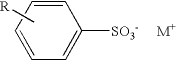

where R is linear alkyl chain of 8 to 15 carbon atoms and M⁺ is a solubilising cation, especially sodium, is also a commercially significant anionic surfactant.

Frequently, such linear alkyl benzene sulphonate or primary alkyl sulphate of the formula above, or a mixture thereof, will be the desired anionic surfactant and may provide 75 to 100 wt % of any anionic non-soap surfactant in the composition.

In some forms of this invention the amount of non-soap anionic detergent lies in a range from 5 to 20 wt % of the tablet composition.

It may also be desirable to include one or more soaps of fatty acids. These are preferably sodium soaps derived from naturally occurring fatty acids, for example, the fatty acids from coconut oil, beef tallow, sunflower or hardened rapeseed oil.

Suitable nonionic detergent compounds which may be used include in particular the reaction products of compounds having a hydrophobic group and a reactive hydrogen atom, for example, aliphatic alcohols, acids, amides or alkyl phenols with alkylene oxides, especially ethylene oxide either alone or with propylene oxide.

Specific nonionic detergent compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine. Other nonionic detergent compounds include alkylpolyglycosides, long-chain amine oxides, tertiary phosphine oxides, and dialkyl sulphoxides.

Especially preferred are the primary and secondary alcohol ethoxylates, especially the C₉₋₁₁ and C₁₂₋₁₅ primary and secondary alcohols ethoxylated with an average of from 5 to 20 moles of ethylene oxide per mole of alcohol.

In certain forms of this invention the amount of nonionic detergent lies in a range from 4 to 40 wt %, better 4 or 5 to 30 wt % by weight of the composition.

Many nonionic detergent-active compounds are liquids. These may be absorbed on a porous carrier or on particles of the composition. Preferred carriers include zeolite; zeolite granulated with other materials, for example Wessalith CS (Trade Mark), Wessalith CD (Trade Mark) or Vegabond GB (Trade Mark); sodium perborate monohydrate; Burkeite (spray-dried sodium carbonate and sodium sulphate as disclosed in EP-A-221776 of Unilever); and layered sodium silicate as described in U.S. Pat. No. 4,664,839.

Amphoteric or zwitterionic detergent compounds may also be used in the compositions of the present invention, but this is not normally desired due to their relatively high cost. If any amphoteric or zwitterionic detergent compositions are used it is generally in small amounts in compositions which are based on the much more commonly used synthetic anionic and/or nonionic detergent compositions.

Additional Perfumes

As a result of the high affinity of the perfume with the clay component and the resulting high stability of the perfume in the perfumed clay, it may be desirable to add further perfumes to the tablet composition which are not pre-adsorbed and/or pre-absorbed onto the clay particles. For example, an additional perfume may be applied to the detergent active component, and this perfume would be sensed by the user before and during use of the product. Then, because the perfumed clay component completely disintegrates in the wash solution during use, the perfume applied thereto will be deposited onto the fabric, and will be sensed by the user once the articles being washed are removed from the machine.

If an additional perfume is employed, it may be present in an amount of from 0.1 to 3% by weight of the tablet, preferably from 0.1 to 0.5%. Suitable perfumes include those listed above in relation to the perfumed clay component. If present in a multi-layer tablet, the additional perfume may be contained in the same tablet zone as the perfumed clay. However, it is preferable that the additional perfume is contained in a different zone to the perfumed clay.

The additional perfume may be applied by any convenient process, although spraying is preferred.

Detergency Builder

The detergency builder is preferably present in an amount of 15 wt %-70 wt %, more preferably from 15 to 60 wt %, e.g. 20-55 wt %. Especially preferred are compositions comprising 15 to 60 wt % of water-insoluble detergency builder.

The detergency builder may be provided wholly by water-soluble materials, or may be provided in large part or even entirely by water-insoluble materials with water-softening properties.

Alkali-metal aluminosilicates are strongly favoured as environmentally acceptable water-insoluble builders for fabric washing. Alkali metal (preferably sodium) aluminosilicates may be either crystalline, amorphous or mixtures thereof, having the general formula:

0.8-1.5 Na₂O. Al₂O₃. 0.8-6 SiO₂.xH₂O

These materials contain some bound water (indicated as “xH₂O”) and are required to have a calcium ion exchange capacity of at least 50 mg CaO/g.

The preferred sodium aluminosilicates within the above formula contain 1.5-3.5 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB-A-1 429 143 (Procter & Gamble). The preferred sodium aluminosilicates of this type are the well known commercially available zeolites A and X, the novel zeolite P described and claimed in EP-A-384070 (Unilever) and mixtures thereof.

Conceivably a water-insoluble detergency builder could be a layered sodium silicate as described in U.S. Pat. No. 4,664,839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3417649 and DE-A-3742043. Other such layered silicates, such as those having the general formula NaMSiₓO_{2x+1.y}H₂O wherein M is sodium or hydrogen, x is a number from 1.9 to 4, preferably 2, and y is a number from 0 to 20, preferably 0 can be used.

Water-soluble phosphorous-containing inorganic detergency builders, include the alkali-metal orthophosphates, metaphosphates, pyrophosphates and polyphosphates. Specific examples of inorganic phosphate builders include sodium and potassium tripolyphosphates, orthophosphates and hexametaphosphates.

Non-phosphorous water-soluble builders may be organic or inorganic. Inorganic builders that may be present include alkali metal (generally sodium) carbonate; while organic builders include polycarboxylate polymers, such as polyacrylates, acrylic/maleic copolymers, and acrylic phosphonates, monomeric polycarboxylates such as citrates, gluconates, oxydisuccinates, glycerol mono-, di- and trisuccinates, carboxymethyloxysuccinates, carboxymethyloxymalonates, dipicolinates and hydroxyethyliminodiacetates.

Tablet compositions preferably include polycarboxylate polymers, more especially polyacrylates and acrylic/maleic copolymers which can function as builders and also inhibit unwanted deposition onto fabric from the wash liquor. Nitrilo triacetate may also be used as the builder. The trisodium salt is especially preferred.

Bleach System

Tableted detergent compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), which is now in widespread commercial use in conjunction with sodium perborate; and perbenzoic acid precursors. The quaternary ammonium and phosphonium bleach activators disclosed in U.S. Pat. No. 4,751,015 and U.S. Pat. No. 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272.

A bleach system may also include a bleach stabiliser (heavy metal sequestrant) such as ethylenediamine tetramethylene phosphonate and diethylenetriamine pentamethylene phosphonate.

As indicated above, if a bleach is present and is a water-soluble inorganic peroxygen bleach, the amount may well be from 10% to 25% by weight of the composition.

It is known that bleaches and their precursors may react with the more volatile components of the perfume contained in detergent tablets. It may therefore be desirable to reduce the interaction between these components, for example by maintaining them in different zones of a multi-zone tablet. In a preferred dual-layer embodiment, the perfumed clay component is present in the first layer and the bleach component is present in the second layer which is essentially free of perfumed clay.

Other Fabric Softeners

Although the clay component in the tablet acts as a fabric softener, it may be desirable to use additional fabric softening agents, although the invention includes tablets where the clay components are the only fabric softeners. The total amount of fabric softening agents, including the amount of clay component, in the tablets of the invention will, in general, be from 0.5 or 3 wt % up to 30 or 50 wt % of the tablet. The lower limit may be as high as 5 wt % and the upper limit as low as 10 wt %.

A discussion of materials which are known as fabric softening agents and which may be used in the tablets of the present invention is found in WO-A-94/24999.

Many suitable and commercially important fabric softening agents are organic compounds containing quaternary nitrogen and at least one carbon chain of 6 to 30 carbon atoms, e.g. in an alkyl, alkenyl or aryl substituted alkyl or alkenyl group with at least six aliphatic carbon atoms.

Other suitable fabric softening agents are the analogous tertiary amines and imidazolines, other aliphatic alcohols, esters, amines or carboxylic acids incorporating a C₈ to C₃₀ alkyl, alkenyl or acyl group, including esters of sorbitan and esters of polyhydric alcohols, and mineral oils. Certain clays are important as fabric softening agents. Another class of materials used as fabric softening agents are hydrophobically modified cellulose ethers.

Some specific instances of fabric softening agents which may be used in tablets of the present invention are:

(1) Acyclic Quaternary Ammonium Compounds

Acyclic quaternary ammonium compounds wherein two N-substituents are hydrocarbyl groups containing from 15 to 22 carbon atoms, the third N-substituent is a saturated alkyl or hydroxy alkyl group containing from 1 to 4 carbon atoms, and the fourth substituent may be defined as for either of the other substituents or may be phenyl. The counter-anion is preferably selected from halide, methyl sulphate and ethyl sulphate radicals.

Throughout this discussion of fabric softening agents, the expression hydrocarbyl group refers to alkyl or alkenyl groups optionally substituted or interrupted by functional groups such as —OH, —O—, COHN, —COO— etc.

Representative examples of these quaternary softeners include ditallow dimethyl ammonium chloride; di(hydrogenated tallow) dimethyl ammonium chloride; di(coconut) dimethyl ammonium chloride; di(coconut) dimethyl ammonium methosulphate.

(2) Ester Quaternary Ammonium Salts

A number of quaternary ammonium salts containing ester groups, including those disclosed in FR-A-2054337 (BASF), EP-A-345842 A2 (Procter), EP-A-239910 (Procter) and U.S. Pat. No. 4,137,180 (Lever) are suitable for use in the tablets of the present invention. Examples of suitable materials include N,N-di(tallowyloxyethyl), N-methyl, N-hydroxyethyl ammonium chloride and 1,2-ditallowyloxy-3-trimethyl ammoniopropane chloride. In these materials, tallowyl may be replaced with cocoyl, palmoyl, lauryl, oleyl, stearyl and palmityl groups.

3) Quaternary Imidazolinium Salts

A further class of cationic softener materials is the imidazolinium salts of generic formula (I)

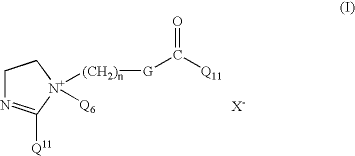

wherein Q₁₁ is a hydrocarbyl group containing from 6 to 24 carbon atoms, G is —N(H)—, or —O—, or —NQ₂-, n is an integer between 1 and 4, and Q₂ and Q₆ are as defined above.

Preferred imidazolinium salts include 1-methyl-1-(tallowylamido) ethyl-2-tallowyl-4,5 dihydro imidazolinium methosulphate and 1-methyl-1-(palmitoylamido) ethyl-2-octadecyl-4,5-dihydroimidazolinium chloride. Other useful imidazolinium materials are 2-heptadecyl-1-methyl-1-(2 stearylamido) ethyl imidazolinium chloride and 2-lauryl-1-hydroxyethyl-1-oleyl imidazolinium chloride. Also suitable are the imidazolinium fabric softening components of U.S. Pat. No. 4,127,489.

4) Primary, Secondary and Tertiary Amines

Primary, secondary and tertiary amines are useful as softening agents. One N-substituent is a hydrocarbyl group containing from 6 to 24 carbon atoms, the second N-substituent is hydrogen or a hydrocarbyl group containing from 1 to 22 carbon atoms and the third N-substituent can be hydrogen or a hydrocarbyl group containing from 1 to 6 carbon atoms. Preferably amines are protonated with hydrochloric acid, orthophosphoric acid or citric acid or any other similar acids for use in cleaning compositions of the present invention. Specific examples of tertiary amines that are suitable for use in the tablets of the present invention are those disclosed in EP-A-213720 (Unilever).

5) Cellulase

British Patent Specification GB-A-1 368 599 (Unilever) discloses the use of cellulolytic enzymes, i.e. cellulases, as harshness reducing agents. It is thought that cellulase achieves its anti-harshening effect on, e.g. cotton, by cleaving the cellulosic fibrils which form on the cotton fibres during the normal washing process. This cleavage prevents the fibrils from bonding together and thereby introducing a degree of rigidity into the fabric.

It is preferred to use cellulases which have an optimum activity at alkaline pH values, such as those described in British Patent Specifications GB-A-2 075 028 (Novo Industrie A/S), GB-A-2 095 275 (Kao Soap Co Ltd) and GB-A-2 094 826 (Kao Soap Co Ltd).

Examples of such alkaline cellulases are cellulases produced by a strain of Humicola insolens (Humicola grisea var. thermoidea), particularly the Humicola strain DSM 1800, cellulases produced by a fungus of Bacillus N or a cellulase 212-producing fungus belonging to the genus Aeromanas, and cellulase extracted from the hepatopancreas of a marine mollusc (Dolabella Auricula Solander).

The amount of cellulase in a tablet of the invention will, in general, be from 0.1 to 10% by weight. In terms of cellulase activity the use of cellulase in an amount corresponding to from 0.25 to 150 or higher regular Cₓ units/gram of detergent composition is within the preferred scope of the present invention. A most preferred range of cellulase activity, however, is from 0.5 to 25 regular Cₓ units/gram of the detergent composition.

Other Detergent Ingredients

The detergent tablets of the invention may also contain one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N. V., Delft, Holland; and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction of a detergent composition to form a tablet.

Similarly to the bleach component, it is known that enzymes may react with perfume in the detergent tablet, and it is therefore desirable to prevent any interaction between the two components, for example by containing them in different zones of a multi-zone tablet. In a preferred dual-layer tablet, the perfumed clay component is present in the first layer, and any enzymes are present in the second layer which is essentially free of perfumed clay.

The detergent tablets of the invention may also contain a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included, especially if the detergent tablet is primarily intended for use in front-loading drum-type automatic washing machines. Suitable antifoam materials are usually in granular form, such as those described in EP-A-266863 (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition.

The detergent tablets may also contain a disintegrant. Suitable disintegrants include smectite clays (which are discussed above in relation to their fabric softening properties). Other suitable, non-clay, disintegrants include sodium citrate dihydrate, potassium carbonate, penta-sodium triphosphate, urea, sodium acetate in its anhydrous or trihydrate form, sodium acetate which is partially hydrated, magnesium sulphate.7H₂O and potassium acetate. Mixtures of these can also be used. Another suitable class of disintegrants comprises cellulose disintegrants.

Further ingredients which can optionally be employed in the detergent tablet of the invention include anti-redeposition agents such as sodium carboxymethylcellulose, straight-chain polyvinyl pyrrolidone and the cellulose ethers such as methyl cellulose and ethyl hydroxyethyl cellulose, heavy metal sequestrants such as EDTA, and pigments, colorants or coloured speckles.

Particle Size and Distribution

A detergent tablet of this invention, or a discrete region of such a tablet, is a matrix of compacted particles.

Preferably the particulate composition has an average particle size in the range from 200 to 2000 μm, more preferably from 250 to 1400 μm. Fine particles, smaller than 180 μm or 200 μm may be eliminated by sieving before tableting, if desired, although we have observed that this is not always essential.

Tableting

Tableting entails compaction of a particulate composition. A variety of tableting machinery is known, and can be used. Generally it will function by stamping a quantity of the particulate composition which is confined in a die.

Manufacture of a tablet with two layers of differing composition may be carried out by placing a predetermined quantity of one composition in a mould, then adding a second composition on top, and next driving a die into the mould to cause compression.

Alternatively, a predetermined quantity of a first composition may be placed in a mould and compacted by driving a die into the mould, followed by removing the die, adding a second composition and compacting again.

Tableting machinery able to carry out such operations is known. For example, suitable tablet presses are available from Fette and from Korsch.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

It is known to make tablets using microwave radiation. WO-A-96/06156 mentions that hydrated materials are useful in this special circumstance to cause sintering.

For the present invention, if any heat is supplied, it is envisaged that this will be supplied conventionally, such as by passing the particulate composition through an oven, rather than by any application of microwave energy.

The size of a tablet will suitably range from 10 to 160 grams (gm), preferably from 15 to 60 gm, depending on the conditions of intended use, and whether the tablet represents a dose for an average load in a fabric washing or a fractional part of such a dose. The tablets may be of any shape. However, for ease of packaging they are preferably blocks of substantially uniform cross-section, such as cylinders or cuboids. The overall density of a tablet is preferably 1040 or 1050 gm/litre, better 1100 gm/litre, up to 1300 or 1350 gm/litre or even more. The tablet density may well lie in a range up to no more than 1250 or even 1200 gm/litre.

While the starting particulate composition may in principle have any bulk density, the present invention is especially relevant to tablets made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 g/litre, preferably at least 500 g/litre, and advantageously at least 700 g/litre.

Granular detergent compositions of high bulk density prepared by granulation and densification in a high-speed mixer/granulator, as described and claimed in EP-A-340013 (Unilever), EP-A-352135 (Unilever), and EP-A-425277 (Unilever), or by the continuous granulation/densification processes described and claimed in EP-A-367339 (Unilever) and EP-A-390251 (Unilever), are inherently suitable for use in the present invention.

Preferred embodiments of the invention will now be described by way of example only. Further modification within the scope of the present invention will be apparent to the person skilled in the art.

### EXAMPLES

In the following Examples describing tablets according to the present invention, these tablets have two layers and the following general formulation:

### Example 1

Bottom (non-clay) layer:

| | |
|---|---|
| Na-LAS | 8.3% |
| Nonionic 7EO + 3EO mix | 3.7% |
| Zeolite (anhydrous) | 18.6% |
| NaAc.3aq/zeolite | 27.4% |
| Light soda ash | 2.8% |
| Moisture, salts, NDOM | 3.3% |
| Fluorescer adjunct | 1.4% |
| Na-disilicate | 2.8% |
| Na-citrate.2aq | 2.8% |
| TAED | 5.7% |
| Percarbonate | 17.1% |
| Antifoam | 2.0% |
| Minors | 4.0% |

Top (clay-containing) layer:

| | |
|---|---|
| Na-LAS | 9.7% |
| Nonionic 7EO + 3EO mix | 4.3% |
| Zeolite (anhydrous) | 21.8% |
| NaAc.3aq/zeolite | 2.8% |
| Light soda ash | 3.2% |
| Moisture, salts, NDOM | 3.9% |
| Clay | 50% |
| Perfume | 3% (6 wt. % perfume pre-applied to clay) |
| Minors | 1.26% |

The bottom layer constitutes 80 wt % of the overall tablet, and the top layer constitutes 20 wt %. The tablets had an average weight of 42.8 grams.

The comparative examples below use a modified version of the general formulation given above, differing in the mode of application of perfume (e.g. spraying as opposed to using perfumed clay) and/or the location of the perfume (e.g. in the bottom (non-clay) layer as opposed to the top (clay-containing) layer).

Examples 1 to 3 relate to rate of dissolution of tablets prepared according to the invention compared to those of the prior art. The formulations tested differ in the mode of application of perfume and in the type of clay used. In all cases, the t90 value is measured, this being the time during which the conductivity of a given amount of water in which a detergent tablet is dissolved under standard conditions has increased to 90% of its final value. A conductivity electrode is placed in 9 litres of water at 20° C. A porous basket containing a stirrer is immersed in the water, and the water stirred at a speed of 200 rpm. The detergent tablet to be tested is then added to the basket and the conductivity measured as the tablet dissolves. From these data, the t90 value can be determined.

### Example 2

Test tablets were made up according to the general formulation given above, with Detersoft clay, available from Laviosa, as the clay component.

Comparative formulation A contained 0.75 wt % perfume applied as a spray to the bottom (non-clay) layer (i.e. 0.6 wt % perfume based on the total tablet weight).

Formulation B contained a perfumed clay component according to the invention. This component contained 6 wt % of perfume pre-adsorbed and/or pre-absorbed onto the clay (giving a total perfume content of 3 wt % in the top layer, corresponding to 0.6 wt % perfume based on the total tablet weight).

The tablets were stored in closed buckets under ambient conditions for one month. At 2, 21 and 30 days, tablets were removed and their t90 values (in minutes) were measured. The t90 values are shown in the following table:

TABLE I

t90 [min]

| Time/days | Formulation A | Formulation B |
|---|---|---|
| 2 | 4.1 | 3.3 |
| 21 | 5 | 4 |
| 30 | 4.8 | 4.4 |

As can be seen above, the tablet containing a perfumed clay component according to the present invention dissolved more quickly (i.e. had a lower t90 value) than the tablet containing the same level of perfume applied as a spray to the bottom layer, even after storage of the tablets.

### Example 3

Four types of tablet were prepared according to the general formulation given above, with QPC clay, available from Colin Stewart Minerals, used as the clay component.

Comparative formulation C contained no perfume.

Comparative formulation D contained 0.75 wt % perfume applied as a spray to the bottom (non-clay) layer, giving an overall perfume content for the tablet of 0.6 wt %.

Comparative formulation E contained 0.6 wt % of perfume applied as a spray to both layers, giving an overall perfume content for the tablet of 0.6 wt %.

Formulation F, according to the invention, contained a perfumed clay component having 6 wt % of perfume pre-adsorbed and/or pre-absorbed onto the clay (giving a total perfume content of 3 wt % in the top layer, corresponding to 0.6 wt % perfume based on the total tablet weight).

The tablets were stored in closed buckets under ambient conditions. At various intervals tablets were removed and their t90 values (in minutes) were measured. The t90 values are shown in the following table:

TABLE II

t90 [min]

| Time/days | C | D | E | F |
|---|---|---|---|---|
| 1 | 2.8 | 3.9 | — | 3.1 |
| 6 | — | — | 4.1 | — |
| 8 | 3.1 | 4.4 | — | 3.3 |
| 11 | — | — | 4.3 | — |
| 13 | 3.2 | 4.6 | — | 3.6 |
| 20 | — | — | 4.4 | — |
| 22 | 3.1 | 5.0 | — | 4.2 |
| 32 | — | — | 5.2 | — |
| 34 | 3.6 | 5.7 | — | 4.6 |

— indicates that the t90 value was not measured at that time

These data show that tablets containing a perfumed clay component according to the invention dissolve faster (i.e. have a lower t90 value) than those containing perfume applied as a spray or one or both layers. The tablets containing a perfumed clay dissolve almost as fast as similar tablets which contain no perfume at all. This result holds even upon storage of the tablets.

### Example 4

A reference tablet was prepared according to the formulation of the bottom (non-clay) layer given above (i.e. a single-layer tablet which did not contain a clay-containing layer), but also included 0.45% perfume applied as a spray.

A further 9 two-layer tablets having the general formulation given above were also tested, differing in the types of clay component used, and the perfume loading.

Formulations G, H and I used QPC clay (from Colin Stewart Minerals); J, K and L used Laundrosil (Sud Chemie) clay; and M, N and 0 used Detersoft (Laviosa) clay.

Comparative formulations G, J and M contained 0.75 wt % perfume applied as a spray to the bottom (non-clay) layer, giving an overall perfume content for these tablets of 0.6 wt %.

Comparative formulations H, K and N contained 0.6 wt % of perfume applied as a spray to both layers, giving an overall perfume content for the tablets of 0.6 wt %.

Formulations I, L and O, according to the invention, contained a perfumed clay component having 6 wt % of perfume pre-adsorbed and/or absorbed onto the clay (giving a total perfume content of 3 wt % in the top layer, corresponding to 0.6 wt % perfume based on the total tablet weight).

The t90 values, measured 1 day after production, are given in the following table:

TABLE III

| | | QPC | | | Laundrosil | | | Detersoft | | |
|---|---|---|---|---|---|---|---|---|---|---|
| | Ref. | G | H | I | J | K | L | M | N | O |
| t90 | 3.2 | 3.7 | 3.8 | 3.1 | 4.4 | 4.9 | 3.8 | 3.9 | 3.9 | 3.2 |
| [min] | | | | | | | | | | |

These data demonstrate that tablets containing a pre-perfumed clay component according to the invention dissolve faster than those for tablets containing the same level of perfume, but having the perfume applied as a spray. The dissolution rate for the perfumed clay tablets according to the invention is similar to those of a reference formulation with a lower perfume level, where perfume is applied as a spray.

### Example 5

Perfume migration tests have also been carried out on tablets prepared according to the invention in order to demonstrate the effect of using a perfumed clay component on the stability of the perfume.

Tablets prepared according to Formulations K, L, N and O in Example 3 above were stored in a climate room at 37° C./70% RH for four weeks in closed glass jars. After four weeks, the tablet were removed and the two layers carefully separated prior to analysis. A sample of approximately 30-35 g of the bottom (non-clay) layer was Soxhlet-extracted with 500 ml n-pentane. A sample of approximately 9-log of the top (clay) layer was first slurried with 20 ml of demi water to disintegrate the clay to ensure full perfume extraction. Soxhlet extraction was performed with the same volume of n-pentane after the addition of a sufficient amount of a granular water absorbent to the slurry to bind the excess water. After the addition of an internal standard solution of C10:0 methyl ester in acetone, the pentane extracts were concentrated to a volume of roughly 5 ml through evaporation. This extract was cooled down and filtered together with approximately 100 ml of acetone for quantitative transfer. The acetone filtrate was concentrated to an end volume of approximately 5 ml. The remaining solution was qualitatively and quantitatively analysed by means of gas chromatography with flame ionisation and mass spectrometric detection.

The initial and final perfume levels, and the percentage of degraded perfume for Formulations K and L (Laundrosil clay) and N and O (Detersoft clay) are shown in the following table. Formulations K and N are comparative examples, whereas formulations L and O are according to the present invention:

TABLE IV

| | Perfume level (wt. %) | | | | |
|---|---|---|---|---|---|
| | Applied | | After storage | | |
| | | Non-clay | | Non-clay | % |
| Sample | Clay layer | layer | Clay layer | layer | degraded |
| K | 0.6 (20%)^{#} | 0.6 | 0.81 (35%) | 0.37 | 24 |
| L | 3.0 (100%) | 0 | 2.38 (85%) | 0.1 | 7 |
| N | 0.6 (20%) | 0.6 | 0.81 (33%) | 0.41 | 18 |
| O | 3.0 (100%) | 0 | 2.02 (76%) | 0.17 | 10 |

^{#}indicates fraction of the total amount of perfume present in the tablet

These data demonstrate an interaction between the perfume and the clay. If perfume is initially applied to both the clay and non-clay layers as a spray, then the perfume will selectively migrate towards the clay layer over time.

Additionally, if a perfumed clay layer is used, in accordance with the invention, to the clay layer, then little perfume “leakage” to the non-clay layer is observed. Even after four weeks storage, approximately 80 wt % of the perfume is still retained in the clay layer. As the bleach ingredients are, in one embodiment of the invention, applied to the non-clay layer, this strong retention of perfume results in a significant increase in perfume stability when perfumed clay granules are used in a separate clay-layer in the tablet.

### Example 6

Additional perfume migration tests were carried out on two-layer tablets of the same general formulation.

Comparative formulation P contained 0.6 wt % of perfume applied as a spray giving an overall perfume content for the tablet of 0.6 wt %.

Formulation Q, according to the invention, contained QPC as the clay component, and contained a perfumed clay component having 6 wt % of perfume pre-adsorbed and/or pre-absorbed onto the clay (giving a total perfume content of 3 wt % in the top layer, corresponding to 0.6 wt % perfume based on the total tablet weight.

Formulation R, according to the invention, had the same general formulation, but did not contain any post-dose components (i.e. did not contain bleach, enzymes, sequestrant etc.).

The tablets were stored in a climate room for four weeks at 37° C. and 70% RH in closed glass jars. The perfume degradation after that time was then measured according to the protocol given in Example 4:

TABLE V

| Sample | % Degraded |
|---|---|
| P | 25 |
| Q | 5 |
| R | 0 |

These results demonstrate improved perfume stability for tablets containing a perfumed clay component, rather than having perfume applied as a spray. Also, the components present in the post dose have an effect on the perfume stability, as can be seen by considering Formulations Q and R: when the post dose is not added to the formulation (as in R), there is little or no degradation of the perfume.

### Example 7

Bottom layer

Content parts by weight

| Ingredient | Ex VII | Comparison |
|---|---|---|
| Na-LAS | 8.16 | 8.38 |
| Nonionic 7EO | 3.58 | 3.68 |
| Soap | 0.63 | 0.65 |
| Zeolite A24 | 18.23 | 18.72 |
| Carbonate | 2.58 | 2.65 |
| Acetate | 2.34 | 2.40 |
| SCMC | 0.25 | 0.26 |
| Moisture/Salts/NDOM | 3.31 | 3.39 |
| HPA | 37.03 | 38.00 |
| Percarbonate | 13.74 | 11.00 |
| TAED | 2.76 | 2.83 |
| Dequest | 1.22 | 1.25 |
| Na-disilicate | 2.44 | 2.50 |
| Savinase enzyme | 0.38 | 0.39 |
| Antifoam | 1.95 | 2.00 |
| Fluorescer adjunct | 1.41 | 1.45 |
| Blue 29 CI-77007 | 0.00 | 0.00 |
| Bentonite clay | 0.00 | 0.00 |
| Clever 11 perfume | 0.00 | 0.45 |

Top layer

| Ingredient | | |
|---|---|---|
| Na-LAS | 8.53 | 8.37 |
| Nonionic 7EO | 3.74 | 3.68 |
| Soap | 0.66 | 0.65 |
| Zeolite | 19.05 | 18.71 |
| Carbonate | 2.70 | 2.65 |
| Acetate | 2.44 | 2.40 |
| SCMC | 0.26 | 0.26 |
| Moisture/Salts/NDOM | 3.45 | 3.39 |
| HPA | 31.05 | 38.00 |
| Percarbonate | 0.00 | 11.00 |
| TAED | 2.88 | 2.83 |
| Dequest | 1.27 | 1.25 |
| Na-disilicate | 2.55 | 2.50 |
| Savinase enzyme | 0.40 | 0.39 |
| Antifoam | 2.04 | 2.00 |
| Fluorescer adjunct | 1.48 | 1.45 |
| Blue 29 CI-77007 | 0.02 | 0.02 |
| Bentonite clay | 15.27 | 0.00 |
| Clever 11 perfume | 2.24 | 0.45 |

The bottom layer constitutes 80 wt % of the overall tablet and the top layer 20 wt %. The tablets had an average weight of 42.8 grammes.

In example VII the perfume was incorporated into the clay prior to mixing and tableting in the comparative example the perfume was sprayed onto the tablet mix prior to tabletting.

With HPLC analysis the perfume levels of the fresh tablets was checked. Next the tablets were stored in closed glass jars at 20° C. and 65% relative humidity after 4 weeks the perfume level was checked again.

Results:

| | Fresh tablets | 4 weeks |
|---|---|---|
| Ex VII | 100% | 93.3% |
| Comparison | 100% | 73.3% |

### Example 8

Additional tests were performed with oil soluble dyes to create coloured-perfumed clay granules. The dye is first dissolved in the perfume. Next the perfume is sprayed onto the clay to create a visual cue. It has been found that with this simple process, evenly coloured perfume-clay granules can be produced. The process is simple and the amount of dye necessary to create the colour is minimal.

The soluble dyes listed below were tested. Coloured perfume-clay granules were produced by dissolving 0.1 wt % of the dyes listed below in the perfume Sunny Picasso LP2330SP ex Quest (current Surf Orange perfume). The dyes dissolved well in this typical detergent perfume with the exception of Eosine 225 and Pyranine. The perfume was sprayed onto sieved (>500 μm) QPC 200G clay granules ex CSM at a 13 wt % level, based on the weight of the clay.

The coloured clay granules were used to produce double layer tablets with a formulation as in example 7 with a speckled top layer. For double layer tablets with a 20 wt % top layer a nice visual effect can be created by dosing 15 wt % of the coloured clay granules (3 wt % overall) in the top layer.

| | CI | | | | |
|---|---|---|---|---|---|
| Name | name | CI No. | Colour | EC code | Supplier |
| Dibromofluorescein | SOL | 45370 | Red/Org | 1 | Acros |
| | RED 72 | | | | |
| Sudan Orange G | SOL | 11920 | Yel/Org | 1 | Acros |
| | ONG 1 | | | | |
| Sudan Red G | SOL | 12150 | Yel/Red | 1 | Merck |
| | RED 1 | | | | |
| Quinoline | SOL | 47000 | Yel | 3 | Acros |
| Yellow SS | YEL 33 | | | | |
| Waxoline Green | SOL | 61565 | Grn/Blu | 1 | E&E |
| | GRN 3 | | | | Anstead |
| Sudan Red/111 | SOL | 26100 | Red | 3 | E&E |
| | RED 23 | | | | Anstead |

1. A method of making a detergent tablet comprising a clay component, said method comprising the steps of:
(i) adsorbing and/or absorbing a perfume onto the clay component to form a perfumed clay component;
(ii) admixing the perfumed clay component with at least one other functional detergent component; and
(iii) compacting the composition formed in step (ii) into a detergent tablet.

2. A method according to claim 1 wherein in step (i) the perfume is adsorbed and/or absorbed onto the clay component in an amount to provide a perfumed clay component comprising from 0.1 to 30 wt % perfume.

3. A method according to claim 1 wherein the perfumed clay component comprises 0.001 to 0.1 wt % of oil soluble dye.

4. A method according to claim 1 wherein the perfumed clay component comprises from 0.5 to 95 wt % of the detergent tablet.

5. A method according to claim 1 wherein the perfumed clay component comprises from 2 to 20 wt % of the detergent tablet.

6. A method according to claim 1 wherein the at least one other functional detergent component comprises one or more components selected from detergent actives, surfactants, detergency builders, bleaches, enzymes, fabric softeners, antifoams, disintegrants and fluorescers.

7. A method of making a multi-zone detergent tablet comprising the steps of:
(i) forming a first tablet zone according to claim 1
(ii) forming a second tablet zone comprising at least one functional detergent component in contact with said first tablet zone to form a multi-zone detergent tablet.

8. A method according to claim 7 wherein the second tablet zone is substantially free of a perfumed clay component.

9. A method according to claim 7 wherein the functional detergent component in the at least a second tablet zone comprises one or more components selected from surfactants, detergency builders, bleaches, enzymes, fabric softeners, antifoams, disintegrants and fluorescers.

10. A method according to claim 7 wherein the first tablet zone comprises from 5 to 95 wt % of the detergent tablet.

11. Detergent tablet comprising a clay component, wherein a perfume is absorbed and/or adsorbed onto said clay component.

12. Detergent tablet comprising a coloured clay component wherein a perfume and an oil soluble dye are absorbed and/or adsorbed onto said clay component.

13. Clay component suitable for use in a detergent formulation comprising clay particles and a perfume and oil soluble dye absorbed and/or adsorbed onto said particles.
